(19) United States
(12) Patent Application Publication
(10) Pub. No.: US 2007/0041713 A1
(43) Pub. Date: Feb. 22, 2007

(54) Apparatus for reproducing data, method thereof, apparatus for recording the same, method thereof and recording medium

(76) Inventors: Kun Suk Kim, Anyang-si (KR); Jea Yong Yoo, Seongnam-si (KR)

Correspondence Address: HARNESS, DICKEY & PIERCE, P.L.C., P.O. BOX 8910, RESTON, VA, 20195, US

(21) Appl. No.: 11/506,899

(22) Filed: Aug. 21, 2006

Related U.S. Application Data
(60) Provisional application No. 60/709,807, filed on Aug. 22, 2005.
(60) Provisional application No. 60/737,412, filed on Nov. 17, 2005.

(30) Foreign Application Priority Data
Apr. 17, 2006 (KR) 10-2006-0034637

(51) Int. Cl. H04N 7/00

(52) U.S. Cl. 386/95

(57) ABSTRACT

In one embodiment, the method includes reproducing a management table from a recording medium. The management table includes combination information, and the combination information indicates secondary subtitles that are combinable with at least one secondary video stream. The secondary video stream represents the picture-in-picture presentation path with respect to a primary presentation path represented by a primary video stream. One of the secondary subtitles is selectively reproduced based on the combination information.

### FOREIGN PRIORITY INFORMATION

This application claims the benefit of the Korean Patent Application No. 10-2006-0034637, filed on Apr. 17, 2006, which is hereby incorporated by reference in its entirety.

### DOMESTIC PRIORITY INFORMATION

This application claims the benefit of the U.S. Provisional Application Nos. 60/709,807 and 60/737,412 filed Aug. 22, 2005 and Nov. 17, 2005, respectively, which are all hereby incorporated by reference in their entirety.

### BACKGROUND OF THE INVENTION

1. Field of Invention

The present invention relates to a method and an apparatus for reproducing data from and/or recording data in a recording medium or storage and the recording medium.

2. Discussion of Related Art

Recently, optical discs capable of recording large-scale data as record media are widely used. To meet the rising demand for video data of high image quality and audio data of high sound quality, HDIV and MPEG2 have been provided. For instance, if video data amounting to one HDTV movie is stored in a disc with MPEG2 image quality, a high-density recording medium having at least 20Gbyte data storage capacity is demanded.

To meet this demand, Blu-ray disc, HD-DVD (high-definition digital video versatile disc) and the like have been developed as next generation recording media. And, many efforts have been made to develop an optical record player according to high definition recording medium specifications.

However, despite the increasing possibility in recording and reproducing at least two kinds of video stream data simultaneously due to the development of high definition recording media, a suitable reproducing method has not been proposed so far.

### SUMMARY OF THE INVENTION

The present invention relates to a method of managing reproduction of at least one picture-in-picture presentation path.

In one embodiment, the method includes reproducing a management table from a recording medium. The management table includes combination information, and the combination information indicates secondary subtitles that are combinable with at least one secondary video stream. The secondary video stream represents the picture-in-picture presentation path with respect to a primary presentation path represented by a primary video stream. One of the secondary subtitles is selectively reproduced based on the combination information.

In one embodiment, management information is stored in a memory based on the combination information, and one of the secondary subtitles is selectively reproduced based on the management information.

For example, the management information may include a secondary subtitle number identifying one of the secondary subtitles combinable with the secondary video stream, and the secondary subtitle identified by the secondary subtitle number is selectively reproduced.

The present invention also relates to a reproduction apparatus.

In one embodiment, the reproduction apparatus includes a memory unit and a controller. The controller is configured to control reading of a management table from a recording medium. The management table includes combination information, and the combination information indicates secondary subtitles that are combinable with at least one secondary video stream. The secondary video stream represents the picture-in-picture presentation path with respect to a primary presentation path represented by a primary video stream. The controller is configured to store management information in the memory based on the combination information, and to selectively reproduce one of the secondary subtitles based on the management information.

The present invention further relates to a recording medium having a data structure for managing reproduction of at least one picture-in-picture presentation path.

In one embodiment, the recording medium includes a data area and a management area, the data area stores a primary video stream, where the primary video stream representing a primary presentation path. The management area stores management information for managing reproduction of a picture-in-picture presentation path with respect to the primary presentation path. The picture-in-picture presentation path is represented by a secondary video stream. The management information includes combination information, and the combination information indicates subtitles permitted to be displayed in combination with the secondary video stream.

The present invention still further relates to a method and an apparatus for recording the data structure for managing reproduction of at least one picture-in-picture presentation path.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention. In the drawings:

FIG. 1 is a diagram of one embodiment of reproducing data within a recording medium and/or storage via an optical record player;

FIG. 2 is a diagram of a file structure recorded in an optical disc as a recording medium of the present invention;

FIG. 3 is a diagram of a recording structure of an optical disc as a recording medium of the present invention;

FIG. 4 is a diagram for explaining a reproduction of a secondary video according to an embodiment of the present invention;

FIG. 5 is a schematic block diagram of an overall configuration of an optical record player according to an embodiment of the present invention;

FIG. 6A and FIG. 6B are schematic block diagrams of a playback system according to one embodiment of the present invention;

FIG. 7 is a diagram of a data reproducing apparatus utilizing a playback system according to an embodiment of the present invention;

FIG. 8A is an exemplary diagram of a status memory unit provided to a reproducing apparatus according to an embodiment of the present invention;

FIG. 8B is an exemplary diagram of PSR2 as a part of the status memory unit shown in FIG. 8A;

FIGS. 9A to 9C are exemplary diagrams for explaining reproduction of a subtitle according to embodiments of the present invention;

FIG. 10 is an exemplary diagram of syntax of a table including information for a presentation graphic or text subtitle stream according to an embodiment of the present invention; and

FIG. 11 is a flowchart of a method of reproducing data according to an embodiment of the present invention.

### DETAILED DESCRIPTION OF EXAMPLE EMBODIMENTS

Reference will now be made in detail to example embodiments of the present invention, which are illustrated in the accompanying drawings. Wherever possible, the same reference numbers will be used throughout the drawings to refer to the same or like parts.

For the purposes of example only, an optical disc such as a DVD, Blu-ray disc (BD), HD-DVD, NFR (near field recording) disc, etc., will be used as an example recording medium in describing the present invention, but it will be understood that the present invention is not limited to optical discs as the recording medium. For further convenience of explanation, the present invention more particularly takes a “Blu-ray disc (BD)” as an example of a record medium. Yet, it is apparent that the technical idea of the present invention is identically applicable to other record media including HD-DVD and the like.

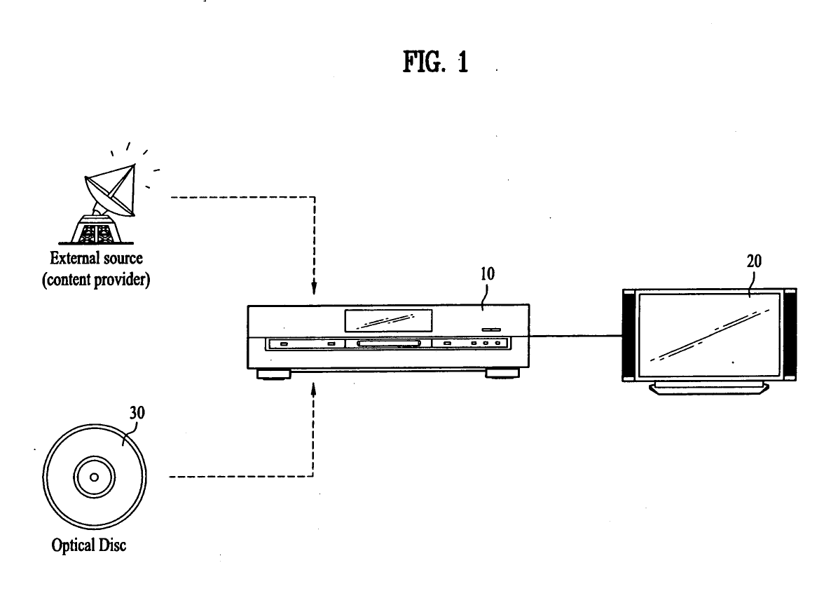

In the present invention, “Storage” may be a storage means provided within an optical record player such as shown in FIG. 1, and means an element which can randomly store information and data. In particular, the storage currently used in general, includes a “hard disc”, “system memory”, “flash memory” or the like, which does not put limitation on the scope of the present invention.

The “Storage” may be utilized as a means for storing data associated with a recording medium. The data associated with the recording medium to be stored within the storage may include data externally downloadable such as from the internet.

It will also be apparent that data directly read out of a recording medium, in part, or a generated system data (e.g., metadata, etc.) associated with reproduction of data recorded in the recording medium may be stored within the storage.

“Contents” in the following description may be data provided by a record medium author as contents configuring a title.

And, a party, who provides content, is generically named a “content provider (CP)”.

For convenience of explanation of the present invention, the data recorded within the recording medium shall be called “original data” and the data obtained outside the recording medium and associated with the recording medium shall be called “additional data”. The original and additional data are classified according to acquisition methods only. So, data existing outside an optical disc and having any kind of attribute associated with original data can be called additional data.

“Title” as used in the following description may be a unit of reproduction configuring an interface with a user. Each title is linked to a specific object. And, a stream associated with the corresponding title recorded within a disc is reproduced according to a command or program within the object. In particular, for explanation convenience of the present invention, a title having a moving picture, movie and interactive information according to MPEG2 compression among titles recorded within a disc shall be named a “HDMV Title”. And, a title having moving picture, movie and interactive information executed by a Java program among titles recorded within a disc shall be named a “BD-J Title”.

“Subtitle” as used in the following description means a graphic or text reproduction unit associated with the title. The “subtitle” may be played back in a plane different from a plane in which the title is played back.

“PiP (Picture-in-Picture)” used in the following description means a function of playing a secondary video on an image of a primary video that is being reproduced.

The above-explained terminologies are replaceable by any terms indicating the same functions, respectively.

FIG. 1 shows one embodiment of reproducing data within a recording medium and/or storage via an optical record player.

Referring to FIG. 1, “Optical record player” 10 according to the present invention enables recording or playback of an optical disc according to various specifications. And, the optical record player 10 can be designed to record/play an optical disc (e.g., BD) of a specific specification. Moreover, the optical record player 10 can be made to play an optical disc only. In the following description of the present invention, by considering interactivity between a Blu-ray disc (BD) and a peripheral device, a BD-player reproducing a Blu-ray disc (BD) or a BD-recorder recording/playing a Blu-ray disc (BD) will be taken as an example. And, it is apparent that the “optical record player” 10 includes a “drive” loadable within a computer or the like.

The optical record player 10 according to the present invention is equipped with a function of recording/playing an optical disc 30 and a function of receiving an external input signal, performing signal-processing on the received signal, and delivering a corresponding image to a user via another external display 20. In this case, no limitation is put on the external input signal. And, a DMB (digital multimedia broadcast) signal, an Internet signal or the like can be a representative one of the external input signals. In case of the Internet, as an easily accessible medium, specific data from the Internet can be downloaded via the optical record player 10.

The original data and the additional data will be explained in detail as follows. For instance, if a multiplexed AV stream for a specific title is recorded as original data within an optical disc and if an audio stream (e.g., English) different from the audio stream (e.g., Korean) of the original data is provided as an additional data from the Internet, a request for downloading the audio stream (e.g., English) as the additional data from the Internet to reproduce together with the AV stream of the original data, or a request for downloading the audio stream (e.g., English) as the additional data from the Internet to reproduce only, may be made by a user. To enable the requests, association between the original data and the additional data is regulated and a systematic method of managing/reproducing the data according to the user's request is provided.

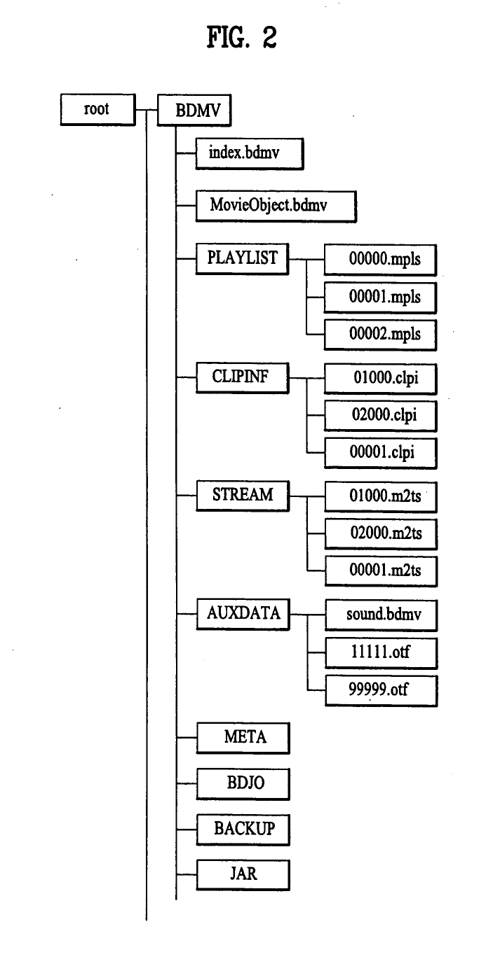

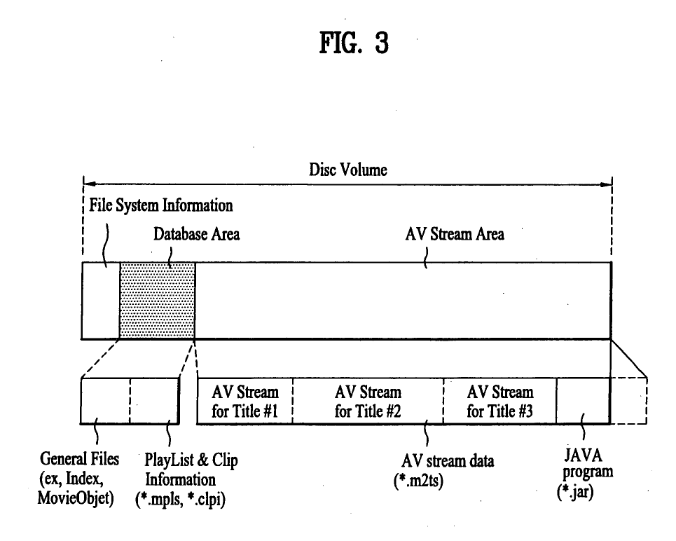

To realize the user's requests, a file structure between the original data and the additional data is provided. File and data structures usable for a Blu-ray disc (BD) are explained in detail with reference to FIG. 2 and FIG. 3 as follows.

FIG. 2 is a diagram of a file structure recorded within an optical disc as a recording medium according to an embodiment of the present invention. In particular, FIG. 2 shows a file structure for reproduction management of original data recorded within a disc.

Referring to FIG. 2, at least one BDMV directory exists below one root directory. An index file (“index”) and an object file (“MovieObject”) as general file (higher file) information to secure interactivity with a user exist within the BDMV directory. And, the BDMV directory includes a playlist directory(“PLAYLIST”), a clipinfo directory(“CLIPINF”), a stream directory(“STREAM”), an auxiliary directory(“AUXDATA”), a BD-J object directory(“BDJO”), a metadata directory(“META”), a backup directory(“BACKUP”) and a JAR director. The BACKUP directory has information of data actually recorded within a disc and information about a method of reproducing the recorded data. The other directories, and the files included in each of the directories, are explained in detail as follows.

The JAR directory includes JAVA program files.

The metadata directory(“META”) includes a metadata file as data about a data. Namely, in the metadata directory(“META”), a search file, a metadata file for Disc Library and the like exist as the metadata files to use for efficient search or management of data.

The BD-J object directory(“BDJO”) includes a BD-J Object file for reproducing a BD-J Title.

The auxiliary directory(“AUXDATA”) includes auxiliary files containing information for a disc playback. For instance, the AUXDATA directory may include a sound file (“Sound.bdmv”) providing click sound in case of an execution of interactive graphic and font files (“11111.otf” and “99999.otf”) providing font information in case of a disc playback.

In the stream directory(“STREAM”), AV stream files recorded within a disc in a specific format exist. Each of the streams is recorded as MPEG-2 transport packets in general, and “.m2ts” is used as an extension of a stream file (01000.m2ts, 02000.m2ts, etc.). In particular, a stream generated from multiplexing video, audio and graphic information together is named an AV stream and at least one or more AV stream files construct a title.

A “Presentation graphic” stream may be applicable to HDMV and BD-J modes and includes information to provide a supplementary image to the associated presentation. The presentation graphic stream typically provides a subtitle and/or other animation graphics during HDMV or BD-J reproduction.

A “Text subtitle” stream is a subtitle based on text provided by a content provider who produces a subtitling application that uses a character code sequence (text) added to style information. A “Text subtitle” stream is stored as an Out-Of-Mux stream separate from a main AV stream, and can provide a subtitle stream without affecting attributes of audio and video reproductions associated with a content provider, in bandwidth.

The above-explained “presentation graphic” stream or “text subtitle” stream may be reproduced by a reproduction player. Yet, both of the “presentation graphic” stream and the “text subtitle” stream may be prohibited from being simultaneously reproduced.

The clipinfo directory(“CLIPINF”) includes clip information files (01000.clpi, 02000.clpi, etc.) one-to-one corresponding to the stream files, respectively. In particular, a clip information file (“*.clpi”) includes attribute information and timing information of the corresponding stream file. In particular, the stream file (“*.m2ts”) and the clip information file (“*.clpi”) corresponding to the stream file (*.m2ts) are called collectively a “clip”. Namely, a “clip” is the data containing both of the stream file (“*.m2ts”) and the clip information file (“*.clpi”).

The playlist directory(“PLAYLIST”) includes playlist files (“*.mpls”). A playlist is a group of playing intervals for reproducing clips. And, a playing interval is called a PlayItem. Each of the playlist files (“*.mpls”) includes at least one PlayItem and SubPlayItem (SPI) designating a playing interval of reproducing a specific clip. The PlayItem and SubPlayItem (SPI) have information about a reproduction start time (IN-Time) and reproduction end time (OUT-Time) of a specific clip. So, the playlist can be called a set of PlayItems. And, metadata for managing a reproduction of a secondary video is included within the playlist file. Moreover, the metadata includes a reproduction time, reproduction position and size of the secondary video in association with the reproduction of the secondary video.

A reproduction process within PlayList file by at least one PlayItem is called “main path” and a reproduction process within PlayList file by each SubPlayItem is called “sub path”. The main path provides a master presentation of a playlist and the sub path provides auxiliary presentations associated with the master presentation. The main path should exist within the PlayList file and at least one sub path may exist according to a presence of SubPlayItem (SPI).

In the present invention, video data reproduced by the main path is also called primary video, and video data reproduced by the sub path is also called secondary video. A function of reproducing both of the primary and secondary videos by an optical record player may be “PiP (Picture in Picture).

The backup directory BACKUP stores a copy of the index file (“index”) recording information associated with a disc playback among data of the file structure, object files (MovieObject, BD-J Object), unit key file, all playlist files (“*.mpls”) within the playlist directory PLAYLIST, and all clip information files (“*.clpi”) within the clipinfo directory CLIPINF. Since the loss of the files may be fatal to the disc playback, the BACKUP directory stores these files for backup.

It is apparent that the file structure of the present invention is not limited to the above-explained names and positions. Namely, the directories and files should be understood not by their names and positions but by their meanings.

FIG. 3 is a diagram of a data record structure written on an optical disc as a recording medium according to an embodiment of the present invention, which shows how the aforesaid file structure associated information is recorded within a corresponding disc.

Referring to FIG. 3, in view from an inner circumference of a disc, there exist a file system information area as system information for managing an entire file, an area (“database area”) in which PlayList and clip information files are written to reproduce a recorded AV stream (*.m2ts), and an AV stream area in which a stream configured with audio/video/graphic or a JAR file is recorded.

And, an area for recording file information for reproducing contents within the stream area and the like is called a “Reproduction management area” and corresponds to the file system information area or the database area. In some cases, reproduction information of a stream can be recorded in a header of a stream within the stream area. In this case, the header corresponds to the management area as well. So, information associated with playback or reproduction management can be recorded in the “reproduction management area”.

An area for recording file information for reproducing contents within the stream area and the like is called a “Reproduction management area” and corresponds to the file system information area or the database area. In some cases, reproduction information of a stream can be recorded in a header of a stream within the stream area. In this case, the header corresponds to the management area as well. So, information associated with reproduction management can be recorded in the “Reproduction management area”. And, main data and auxiliary data (e.g., AV streams and at least one or more text subtitle streams) are stored within a stream area. In this case, the main data includes audio data, video data and graphic data. The auxiliary data (e.g., text subtitle) is not multiplexed with the main data but is independently stored within the stream area. Each area shown in FIG. 3 is exemplarily proposed. And, it is apparent that the present invention is not limited to the arrangement structure of the areas shown in FIG. 3.

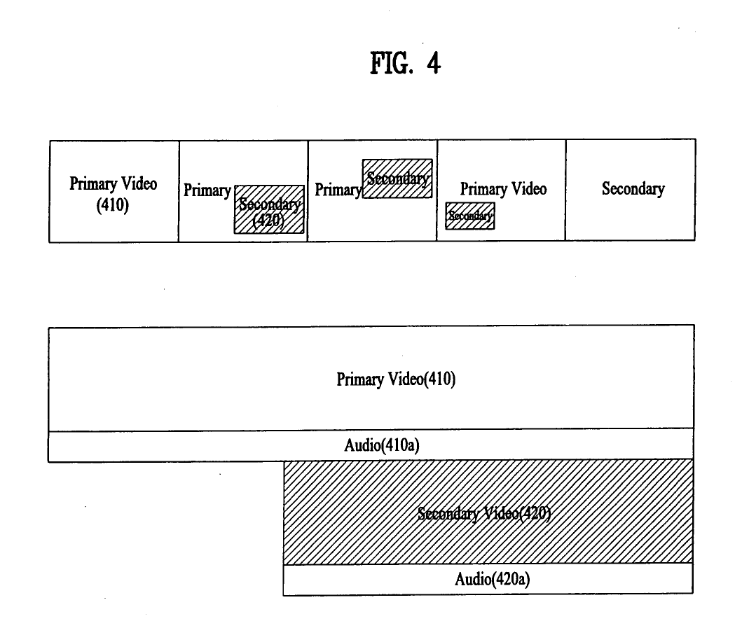

FIG. 4 is a diagram of a reproduction mode of secondary video according to embodiments of the present invention.

One embodiment of playing a secondary video on an image of a primary video that is being played is explained with reference to FIG. 4 as follows.

Referring to FIG. 4, another video data associated with a primary video 410 can be requested to be output to a same display unit 20 while the primary video is being played back. For instance, in the course of playing a movie or documentary, in case that a director's commentary for a shooting process is to be provided to a user, a video showing the commentary can be played back as a secondary video 420 together with the primary video 410. In doing so, the secondary video 420 may be played together with the playback of the primary video 410.

In some cases, a playback of the secondary video 420 may start in the middle of reproducing the primary video 410. And, it is also possible to display the secondary video 420 at a different position or size on a screen according to a playback process. Moreover, it is also possible to start or end a corresponding playback separately from a playback of the primary video 410. The primary video 410 can be played together with an associated audio 410a and the secondary video 420 can be played together with an associated audio 420a.

Information for a play timing point, play position, size of the secondary video and a stream constructing the secondary video is provided to play back the secondary video. And, information for defining an audio stream, presentation graphic or text subtitle stream (e.g., PiP PG textST stream) reproduced together with the secondary video and information for defining a permitted reproduction combination of the streams are provided as well. Moreover, an optical record player is provided with a memory unit (e.g., PSRs) storing a playback status of the secondary video and a playback environment.

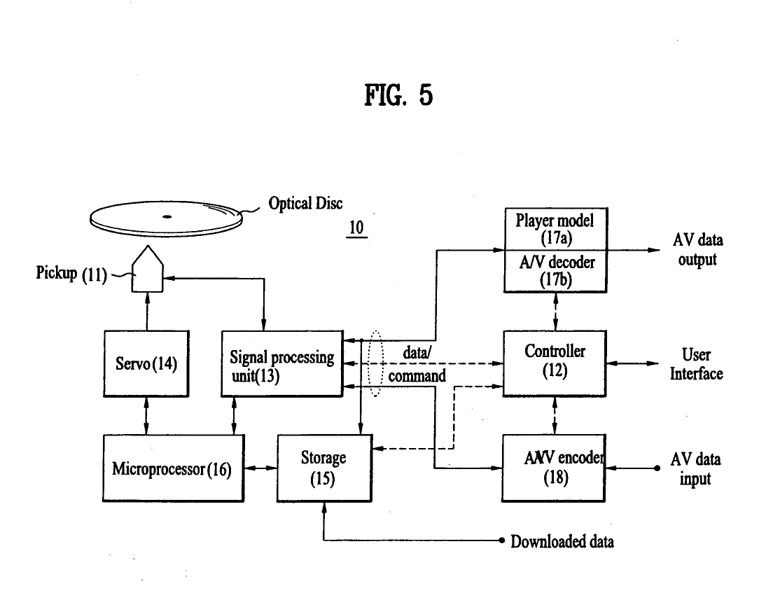

FIG. 5 is a block diagram of an overall configuration of an optical record player according to an embodiment of the present invention.

Referring to FIG. 5, an optical record player 10 according to one embodiment of the present invention includes a pickup 11 for reproducing original data and reproduction management information including file information recorded in an optical disc, a servo 14 for controlling an action of the pickup 11, and a signal processor 13 for restoring a reproduction signal received from the pickup 11 to a specific signal value. The signal processor 13 also modulates a signal to be recorded into a signal recordable on the optical disc. A microprocessor 16 controls the overall operations of these elements.

The pickup 11, the servo 14, the signal processor 13, and the microprocessor 16 are also collectively referred to as a “recording/reproducing unit”. In accordance with the present invention, the recording/reproducing unit reads data from an optical disc 30 or storage 15 under the control of a controller 12, and sends the read data to an AV decoder 17b. The recording/reproducing unit also receives an encoded signal from an AV encoder 18, and records the received signal in the optical disc 30. Thus, the recording/reproducing unit can record video and audio data in the optical disc 30.

The controller 12 downloads additional data present outside the optical disc 30 in accordance with a user command, and stores the additional data in the storage 15. The controller 12 also reproduces the additional data stored in the storage 15 and/or the original data in the optical disc 30 at the request of the user.

The optical recording/reproducing apparatus 10 further includes a playback system 17 for finally decoding data, and providing the decoded data to the user under the control of the controller 12. The playback system 17 includes an AV decoder 17b for decoding an AV signal. The AV decoder 17b may include a plurality of decoders. The playback system 17 also includes a player model 17a for analyzing an object command or application associated with playback of a particular title, for analyzing a user command input via the controller 12, and for determining a playback direction, based on the results of the analysis. In an embodiment, the player model 17a may be implemented as including the AV decoder 17a. In this case, the playback system 17 is the player model itself.

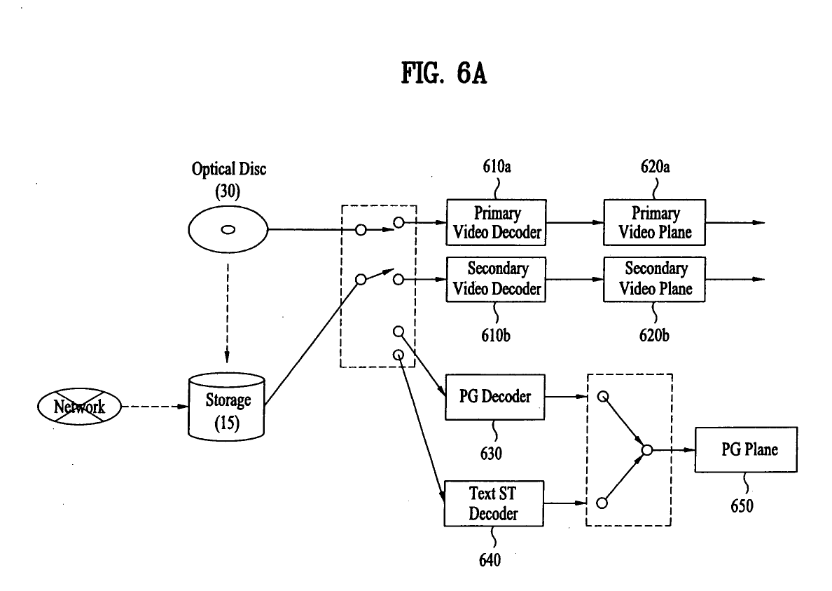

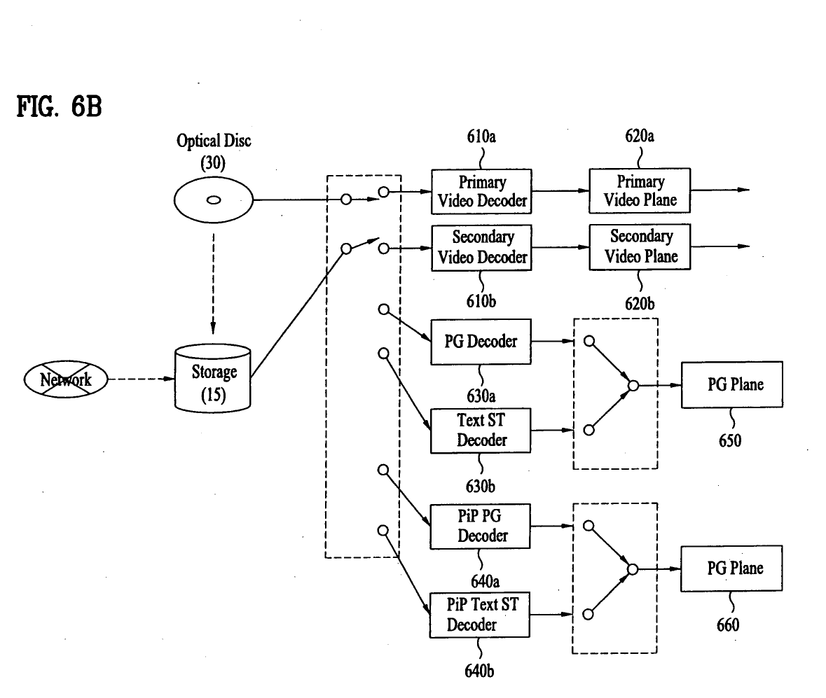

FIG. 6A and FIG. 6B are schematic block diagrams of a playback system according to an embodiment of the present invention.

Referring to FIG. 6A, a decoder 17b according to one embodiment of the present invention includes a primary video decoder 610a decoding a primary video, a secondary video decoder 610b decoding a secondary video, a PG decoder 630 decoding a presentation graphic stream and a text decoder 640 decoding a text subtitle stream. As shown, the various streams are delivered from the optical disc 30 or storage 15 to the decoders via a switching structure.

The PG decoder 630 and the text decoder 640 do not discriminate between the primary and secondary videos. In particular, the PG decoder 630 is capable of decoding a presentation graphic stream associated with the secondary video or the primary video and the text decoder 640 is capable of decoding a text subtitle stream associated with the secondary video or the primary video.

The primary and secondary videos are output via primary and secondary video planes 620a and 620b to be provided to a user, respectively. And, the decoded presentation graphic or text subtitle is output via a PG plane 650. As shown, a combining structure combines the output of the PG decoder 630 and the text decoder 640 for application to the PG plane 650.

The layering or sequence of the planes appearing on a screen are as follows: the primary video plane 620a lies in the lowest layer, the secondary video plane 620b lies on the primary video plane 620a, and the PG plane 650 is displayed on the secondary video plane 620b.

Referring to FIG. 6B, a decoder 17b according to another embodiment of the present invention includes a primary video decoder 610a decoding a primary video, a secondary video decoder 610b decoding a secondary video, PG decoders 630a and 630b decoding presentation graphic streams and text decoders 640a and 640b decoding text subtitle streams. As shown, the various streams are delivered from the optical disc 30 or storage 15 to the decoders via a switching structure.

The PG decoder 630a is capable of decoding a presentation graphic stream associated with the primary video, while the PiP PG decoder 630b is capable of decoding a presentation graphic stream associated with the secondary video. The text decoder 640a is capable of decoding a text subtitle stream associated with the primary video, while the PiP text decoder 640b is capable of decoding a text subtitle stream associated with the secondary video.

The decoded presentation graphic or text subtitle is outputted via a PG plane 650. As shown, a combining structure combines the output of the PG decoder 630a and the text decoder 630b for application to the PG plane 650. The PiP presentation graphic or decoded text subtitle associated with the secondary video is output via a PiP PG plane 660. As shown, a combining structure combines the output of the PiP PG decoder 640a and the PiP text decoder 640b for application to the PiP PG plane 660.

The controller 12 checks reproduction management data of the secondary video and controls the secondary video decoder 610b so that the secondary video may be decoded for display at a specific position and size and at a specific timing point according to secondary video playback attribute information included in the reproduction management data. Primary and/or secondary video stream data may be recorded in a recording medium 30 or may be downloaded to a storage 15 from outside of the recording medium. In particular, the controller 12 controls the PG decoder 630 or 630b or the text decoder 640 or 640b to decode the presentation graphic or text subtitle associated with the secondary video included in the secondary video reproduction management data.

An output signal decoded by the PG decoder 630 or 630b or the text decoder 640 or 640b is synthesized by an image synthesizing unit (not shown in the drawing) to be displayed on a display unit. In particular, the primary video output via the primary video plane 620a after being decoded by the primary video decoder 610a is displayed on the display unit as a background image. The secondary video decoded by the secondary video decoder 620a is displayed on the background image of the primary video by the secondary video plane 620b. And, an image output via the PiP PG plane 660 after being decoded by the PG decoder 630 or 630b or the text decoder 640 or 640b is overlapped with an image of the secondary video.

The optical record player 10 according to the present invention includes an AV encoder 18. To perform a function of recording a signal on an optical disc, the AV encoder 18 converts an input signal to a signal of a specific format, e.g., an MPEG2 transport stream according to a control of the controller 12 and then provides the converted signal to the signal processing unit 13. Like the AV decoder 17b, the AV encoder 18 can include a plurality of encoders. The controller 12 is able to control the primary and secondary video streams, primary and secondary audio streams, reproduction management data, presentation graphic, text subtitle stream or the like to be recorded on the optical disc.

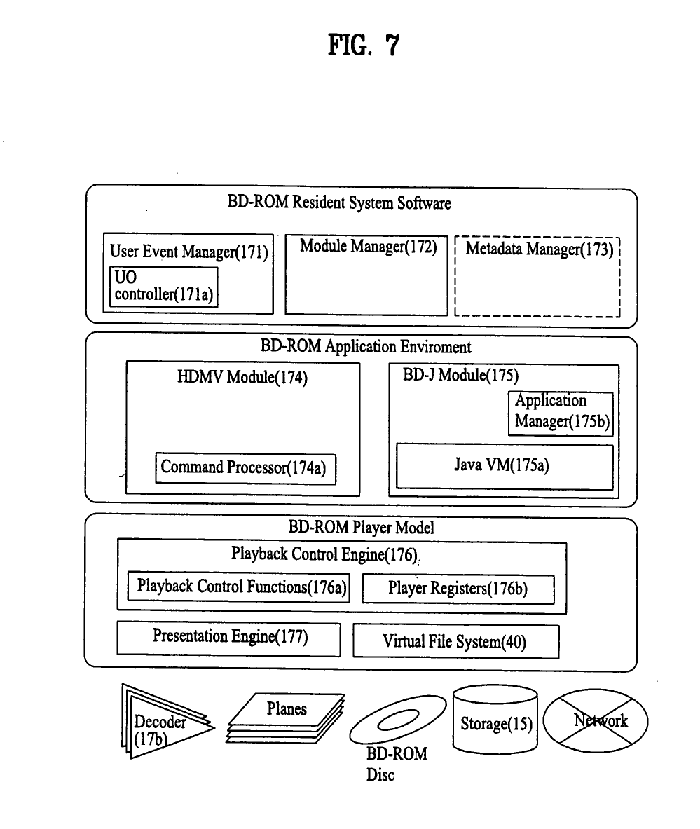

FIG. 7 shows a data reproducing apparatus utilizing a playback system according to an embodiment of the present invention, in which a secondary video is reproduced together with a primary video by the data reproducing apparatus.

Referring to FIG. 7, a “playback system” includes collection of reproduction processing means configured as programs (software) and/or hardware provided within an optical record player and/or stored on the recording medium and downloaded on the optical record player. The playback system plays a recording medium loaded in the optical record player, and simultaneously reproduces and manages the data that is associated with the recording medium such as that stored in a storage (e.g., data downloaded from outside).

In particular, a playback system 17 includes “User Event Manager (171)”, “Module Manager(172)”, a “Metadata Manager (173)”, “HDMV Module(174)”, “BD-J Module(175)”, “Playback control engine(176)”, “Presentation engine(177)” and “Virtual File System(40)”, which are explained in detail as follows.

As separate reproduction processing management means for reproducing HDMV Title and BD-J Title, respectively, the “HDMV Module (174)” for HDMV Titles and the “BD-J Module (175)” for BD-J Titles are independently configured. Each of the “HDMV Module (174)” and the “BD-J Module (175)” has a control function for receiving a command or program within the aforesaid object (Movie Object or BD-J Object), and processing the command or program. The “Metadata Manager (173)” is able to perform a title selection and to provide a recording medium and title metadata to a user at any time under a user's control. The “HDMV Module (174)” and “BD-J Module (175)” enable a portability of a command or application by separating the command or application from a hardware configuration of the playback system. As a means for receiving to process the command, application or the like, a “Command processor (174a) is provided within the “HDMV Module (174), and a “Java VM (175a)” and an “Application manager (175b)” are provided within the “BD-J Module (175).

The “Java VM (175)” is “Virtual Machine” (VM) executing an application. The “Application manager (175b)” includes an application management function of managing a lifecycle of an application.

Moreover, the “Module Manager (172)” is provided to deliver a user command to the “HDMV Module (174)” or the “BD-J Module (175)” and to control an operation of the “HDMV Module (174)” or the “BD-J Module (175)”.

A “Playback control Engine (176)”, which is also provided, interprets PlayList file information recorded within a disc according to a reproduction command of the “HDMV Module (174)” or the “BD-J Module (175)” and performs a corresponding reproduction function. Moreover, a “Presentation Engine (177)” for decoding a specific stream reproduced and managed by the “Playback Control Engine (176)”, and for displaying the decoded stream on a screen is provided. Specifically, the “Playback Control Engine (176)” includes “Playback Control functions (176a)” actually managing reproductions and “Player Registers (176b)” storing player status registers (PSRs) and general purpose registers (GPRs). In some cases, “Playback Control functions (176a)” may mean “Playback Control Engine (176)”.

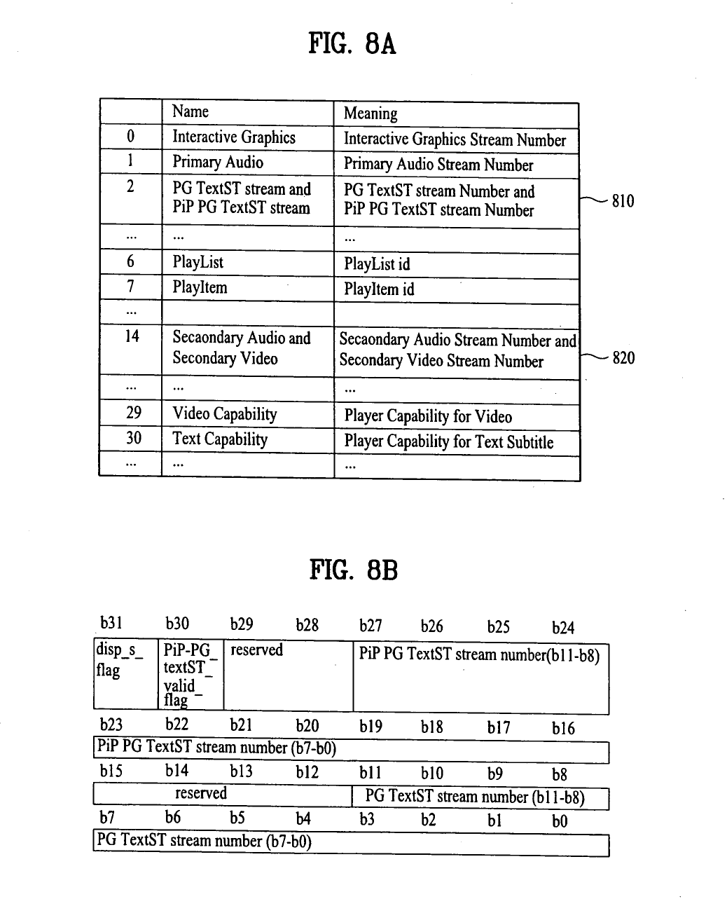

In an embodiment of the present invention, the “Player registers (176b)” becomes a memory unit indicating a playback status of the secondary video. The memory unit will be explained in detail with reference to FIGS. 8A and 8B later.

The HDMV title and BD-J title receive user commands in separate types, respectively, and independently perform the user commands. A means for receiving and delivering a user command to either the “HDMV Module (174)” or “BD-J Module (175)” is provided by the “User Event Manager (171)”. So, if a received command is a user command by “User Operation (UO)”, the “User Event Manager (171)” transfers it to the “Module Manager (172)” or “UO controller (171a)” to perform the user command. If a received command is a user command by “Key Event”, the “User Event Manager (171)” transfers it to the “Java VM (175a)” within the “BD-J Module (175)” to perform the user command.

And, the playback system 17 according to the present invention may include the “Metadata Manager (173)” that provides disc library and enhanced search metadata applications to a user.

In the above-explained playback system of the present invention, the “Module Manager (172)”, the “HDMV Module (174)”, the “BD-J Module (175)” and the “Playback Control Engine (176)” are enabled in software. Software processing tends to be more advantageous than a hardware configuration in design. Yet, the “Presentation Engine (177)”, the decoders and the planes are normally designed by hardware. In particular, the elements (e.g., reference numbers 172, 174, 175, 176) performed by software can be configured with a portion of the controller 12. Hence, the configuration of the present invention should be understood by its meaning but is not limited to a hardware configuration or a software configuration.

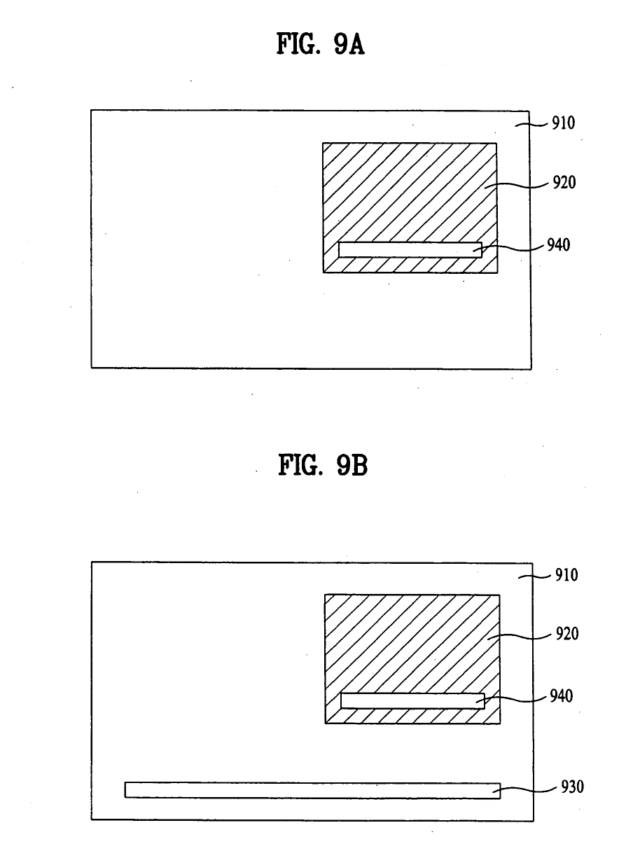

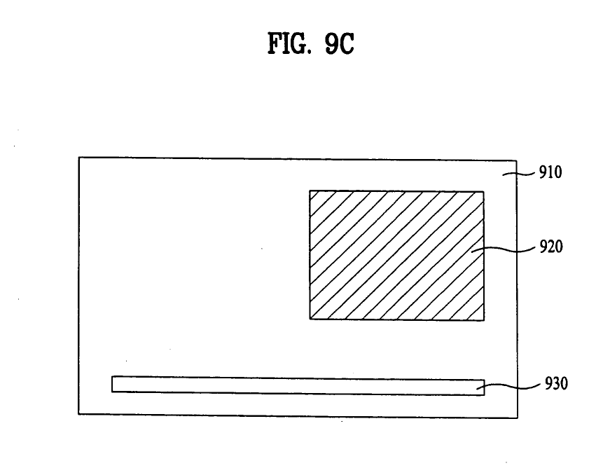

FIG. 8A is an exemplary diagram of a status memory unit provided in a reproducing apparatus according to an embodiment of the present invention and FIG. 8B is an exemplary diagram of PSR2 as a part of the status memory unit shown in FIG. 8A. FIGS. 9A to 9C are exemplary diagrams for explaining a reproduction of a subtitle according to an embodiment of the present invention. One embodiment of the present invention is explained with reference to these drawings as follows.

An optical record player 10 includes “Player Registers (176b)” as sort of memory units storing information for record playback status and environment of the player. The “Player Registers (176b)” can be divided into “General purpose Registers (GPRs)” and “Player Status Registers (PSRs)”.

The “Player Status Registers (PSRs)” can be divided into “Playback Status Registers” storing playback status parameters (e.g., ‘interactive graphics stream number’ and ‘primary audio number’) and “Player Setting registers” storing optical record player configuration parameters.

In the embodiment of the present invention, “Player Status Registers (PSRs)” storing a playback status of a secondary video are provided to play back the secondary video as well as a primary video. In particular, the present invention relates to a PSR2 storing information for a secondary video associated presentation graphic or text subtitle played over the secondary video.

First of all, a PSR14 820 as one of the “Player Status Registers (PSRs)” includes a “secondary video stream number” field. A secondary video stream number is stored in the “secondary video stream number” field. In this case, the secondary video stream number is used in specifying the secondary video stream that should be presented from secondary video stream entries within an STN table of a current playitem.

A “disp_v_flag” is also stored in the PSR14 820. In this case, “disp_v_flag” is a flag indicating whether the display of the secondary video is enabled or disabled. For instance, if the flag “disp_v_flag” is set to ‘disable’ (0_{b}), the display is not executed although the secondary video may still be decoded by the decoder 610b. Hence, a user is unable to view the secondary video. On the other hand, if the flag “disp_v_flag” is set to ‘enable’ (1_{b}), the secondary video is decoded by the decoder 610b and displayed. Hence, a user is able to view the secondary video via the secondary video plane 620b.

A value of the flag “disp_v_flag” can be changed by a command generated from a user operation (UO), playback system or application programming interface (hereinafter abbreviated API).

In the present invention, a secondary video can be reproduced together with a presentation graphic or text subtitle (hereinafter abbreviated ‘PG Text ST’). So, a memory unit (e.g., PSR2 810 shown in FIG. 8B) is provided to store the ‘PG TextST associated with the secondary video (hereinafter called ‘PiP PG TextST).

The PSR2 810 includes a “PG TextST stream number” field, a “PiP PG TextST stream number” field, a “disp_s_flag” field and a “PiP_PG_textST_valid_flag” field.

In the “PG TextST stream number” field, a PG or TextSt stream number (hereinafter abbreviated ‘PG TextST stream number’) associated with the primary video is stored.

The PG TextST stream number is information designating the PG or TextST stream that shall be reproduced among PG TextST stream entries within an STN table of a current playitem if the secondary video is not displayed. In case that the secondary video is not displayed, the flag “disp_v_flag” within the PSR14 820 is set to ‘disable’ or a secondary video stream is not displayed during a current playitem playback.

The PG TextST stream number is a value obtained by adding ‘1’ to a PG TextST stream identifier defined in the STN table, and will be explained later.

On the other hand, in the “PIP PG TextST stream number” field, a PG or TextSt stream number (hereinafter abbreviated ‘PiP PG TextSt stream number’) associated with the secondary video is stored.

The PiP PG TextST stream number is information designating the PG or TextST stream that should be reproduced among PG TextST stream entries within an STN table of a current playitem if the secondary video is displayed. In case that the secondary video is displayed, the flag “disp_v_flag” within the PSR14 820 is set to ‘enable’ and a secondary video stream indicated by the PSR14 820 is displayed during a current playitem playback.

In case that a value stored in the “PG TextST stream number” field is “0×FFF”, it means that a PG TextST stream entry is not selected by the playback system or there exists no PG TextST stream. And, in case that a value stored in the “PiP PG TextST stream number” field is “0×FFF”, it means that PiP PG TextST stream entry is not selected by the playback system or there exists no PG PiP TextST stream.

The PG TextST stream number is a value obtained by adding ‘1’ to a PG TextST stream identifier defined in the STN table, and will be explained later.

The “disp_s_flag” is a flag indicating whether to display a subtitle stream (the PiP PG TextST stream or the PG TextST stream).

If the flag “disp_s_flag” is set to ‘disable (0_{b})’, the PG Text ST stream and PiP PG TextST stream are not displayed. Yet, even if the flag “disp_s_flag” is set to ‘disable (0_{b})’, a graphic or text may be displayed in part. For instance, a composition object of a presentation graphic or a dialog region of a text subtitle may be displayed according to a value of an intrinsic flag (“forced_on_flag”), not shown.

On the other hand, if the flag “disp_s_flag” is set to ‘enable (1_{b})’, a designated PG Text ST stream or PiP TG TextST stream can be displayed to a user. Like the “disp_v_flag” of the PSR14, the flag “disp_s_flag” can be changed by a user operation (UO) or application programming interface (API).

The “PiP_PG_textST_valid_flag” indicates whether the “PiP PG TextST stream number” field is valid or not.

The “PiP_PG_textST_valid_flag” is used in indicating what kind of “PG TextST stream number” field is used in displaying the secondary video stream.

For instance, if the “PiP_PG_textST_valid_flag” is set to “0_{b}”, the “PG TextST stream number” field defined in the PSR2 is used in displaying the secondary video stream.

On the other hand, if the “PiP_PG_textST_valid_flag” is set to “1_{b}”, the “PiP PG TextST stream number” field defined in the PSR2 is used. The “PiP_PG_textST_valid_flag” has no influence on the optical record player according to the present invention if the secondary video stream is not displayed. In this case, the PG TextST stream identifier stored in the “PG TextST stream number” field defined in the PSR2 may be used.

A value of the “PiP_PG_textST_valid_flag” can be changed by a navigation command or application programming interface (API). Herein, the navigation command or application programming interface (API) may be used in making a menu for a user interface (UI). Therefore, if a secondary video stream is displayed on a primary video stream, it is possible to selectively reproduce PiP PG textST stream (a subtitle associated in the secondary video stream) or PG textST stream (a subtitle associated in the primary video stream) according to user's demand.

The PIP PG TextST stream identifier stored within the PSR2 810 is controlled by a selection model of the PiP PG TextST stream.

If a secondary video stream is displayed, the “PiP_PG_textST_valid_flag” within the PSR2 is set to ‘able (‘1_{b}’)’, a value stored in the “PiP PG TextST stream number” field is not “0×FFF” and the “disp_s_flag” within the PSR2 is set to ‘able (‘1_{b}’)’, then a PiP PG Text stream decided by this selection model will be displayed.

This case is shown in FIG. 9A, where a graphic or text 940 associated with a secondary video can be displayed on the secondary video 920 (but a graphic or text subtitle for the primary video 910 is not displayed). In some cases, as shown in FIG. 9B, a graphic or text 930 associated with a primary video is displayed on the primary video 910 and a graphic or text 940 associated with a secondary video can be displayed on the secondary video 920.

On the other hand, if a secondary video stream is displayed, the “PiP_PG_textST_valid_flag” within the PSR2 is set to ‘disable (‘0_{b}’), a value stored in the “PiP PG TextST stream number” field is not “0×FFF” and the “disp_s_flag” within the PSR2 is set to ‘able (‘1_{b}’)’, then a PG Text stream decided by this selection model will be displayed.

This case is shown in FIG. 9C, where a graphic or text 930 associated with a primary video may be displayed on the primary video 910.

Referring to FIG. 8B, the PG textST stream number and the PiP PG textST stream number are stored in the “PG TextST stream number” field and the “PiP TextST stream number” field included in the PSR2, respectively. Meanwhile, the “PiP_PG_textST_valid_flag” having 1-bit allocated thereto indicates whether PiP PG TextST is valid or not. And, the “disp_s_flag” having 1-bit allocated thereto indicates whether PiP PG TextST stream and PG TextST stream is to be displayed or not.

In the aforesaid PSR2, play status information for a subtitle associated with a secondary video to be played according to reproduction management data is stored. The subtitle includes a graphic or text subtitle. The controller 12 checks a subtitle to be played according to the reproduction management data and controls playback status information associated with the checked subtitle to be stored in the PSR2.

The controller 12 is able to control the subtitle to be played back by checking the playback status information stored in the PSR2. In this case, the subtitle is output via a PG plane and is displayed on a secondary video. In this case, the secondary video is displayed on a primary video.

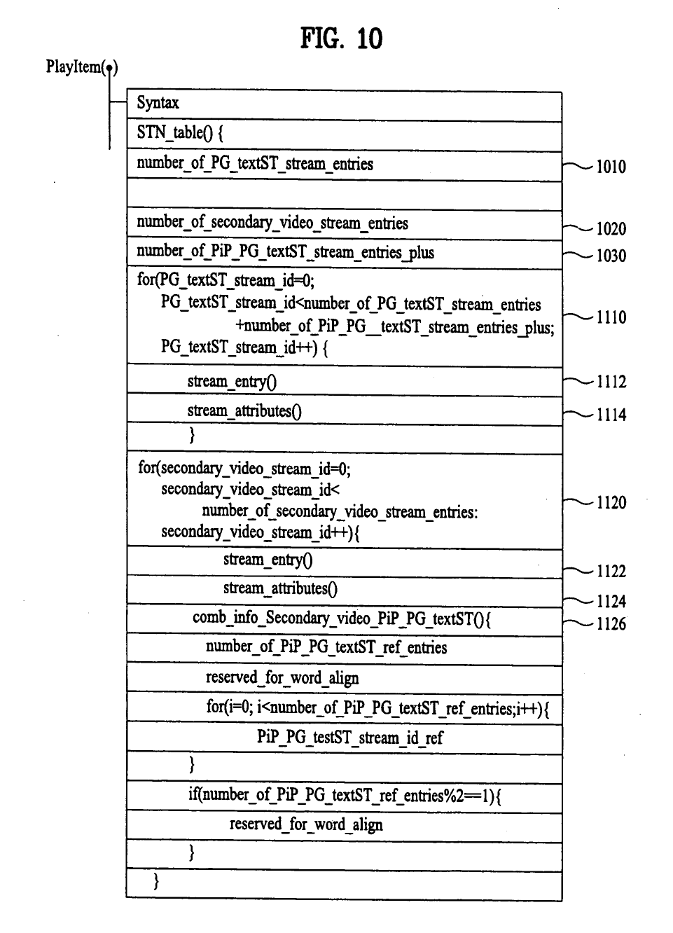

FIG. 10 is an exemplary diagram of syntax of a table including information for a presentation graphic or text subtitle stream according to an embodiment of the present invention.

The table (hereinafter called STN table) defines a list of basic streams that can be selected by an optical record player during a playback of a main path or sub path associated with a current playitem. And, the STN table is provided in each playitem included in a playlist.

The optical record player 10 according to the present invention possesses a function of processing a secondary video, a presentation graphic and a text subtitle. So, the STN table according to the present invention stores entries associated with secondary video, secondary audio, presentation graphic and text subtitle.

Referring to FIG. 10, a “number_of_PG_text_stream_entries” field 1010, a “number_of_secondary_video_stream_entries” field 1020, a “number_of_PiP_PG_textST_stream_entires_plus” field 1030, and fields 1110 and 1120 defining graphic/text entries and secondary video entries, respectively, are included in an STN table according to an embodiment of the present invention.

The “number_of_PG_text_stream_entries” field 1010 indicates a number of the recorded presentation graphics or text stream entries (“PG textST stream entries”).

The “number_of_secondary_video_stream_entries” field 1020 indicates a number of the recorded “secondary video stream entries”.

The “number_of PiP_PG_textST_stream_entires_plus” field 1030 indicates a number of presentation graphics or text stream entries (PG TextST stream entries) for a PiP application.

In association with the PG textST streams, a PG textST stream identifier (“PG textST stream id”) is initialized to ‘0’ ( 110). The PG textST stream identifiers are generated by adding 1 to the previous PG textST identifier as long as the number of the ‘PG textST stream entries (“PG and textST stream entries”) plus the number of ‘PG textST stream entries for PiP application (“PiP PG and textST stream entries”) has not been reached (1110).

In association with the PG textST stream identifier, the “PG textST stream number” explained in the PSR2 is equal to a value resulting from adding 1 to the “PG textST stream id”. And, the “PG textST stream number” is equal to or smaller than the number (1010) of the PG textST stream entries (“PG textST stream entries”).

In association with the PiP PG textST stream identifier, the “PiP PG textST stream id” is equal to the “PG textST stream id”. Hence, the “PiP PG textST stream number” explained in the PSR2 is equal to a value resulting from adding 1 to the “PG textST stream id”.

The “PiP PG textST stream number” is equal to or smaller than a value resulting from adding the number of the “PiP PG textST stream entries” and the “PiP PG textST stream entries” together.

Meanwhile, a “stream entry()” field 1112 indicates information for a PG textST stream entry. For instance, this field indicates information for length and type of a stream. And, depending on the type, this field 1112 can identify the specific stream of a main clip or a sub clip, and may also identify a subpath, for the stream.

A “stream attribute(” field 1114 indicates information for a stream attribute. For instance, this field indicates information for a length and coding type of a stream. This field can identify according to the stream coding type whether a specific stream corresponds to a presentation graphic stream, an interactive graphic stream or a text subtitle (textST) stream. According to the identified type, a language code may be defined if the specific stream is a presentation graphic stream. A character code and a language code are defined if the specific stream is a text subtitle stream.

In association with the secondary video stream, the secondary video stream identifier (“secondary video stream id”) is initialized to ‘0’. The secondary video stream identifiers are obtained by adding 1 to the previous secondary video stream identifier as long as the number of secondary video stream entries (“secondary video stream entries”) defined in the STN table has not been reached (1120).

A “stream entry( )” field 1122 indicates information for a stream entry. For instance, this field indicates information for length and type of a stream. And, depending on the indicated type, the stream entry identifies the specific stream of a main clip or a sub clip, and may also identify a subpath, of the stream.

A “stream attribute( )” field 1124 indicates information for a stream attribute. For instance, this field 1124 indicates information for a video format and frame rate.

In reproducing the secondary video together with the primary video, a PiP PG textST stream may be reproduced. In this case, combination relations between PG textST streams and secondary video streams are possible.

In association with the permitted combinations between the secondary video streams and the PiP PG textST streams, the STN table includes “combo_info_Secondary_video_PiP_PG_textST” field 1126 for each secondary video stream identified in field 1120. This field (“combo_info_Secondary_video_PiP_PG_textST”) defines the permitted combination between the corresponding secondary video streams and ‘PiP PG textST’ streams.

Below the field (“combo_info_Secondary_video_PiP_PG_textST”), the STN table includes a “number of PiP_PG_textST_ref_entries” field and a “Pip_PG_textST_stream_id_ref” field.

The “number of PiP_PG_textST_ref_entries” field indicates a number of presentation graphic streams and text streams permitted in reproducing the secondary video stream.

For each of the a number of presentation graphic streams and text streams, the “PiP_PG_textST_stream_id_ref” field indicates a presentation graphic stream and text stream identifier (PiP_PG_textST_stream_id) permitted in reproducing the secondary video stream. Namely, this field indicates which PG textST stream will be reproduced in playing the secondary video stream.

In addition, playback status information for the presentation graphic stream and text stream identifier (PiP_PG_textST_stream_id) is stored in the PSR 2.

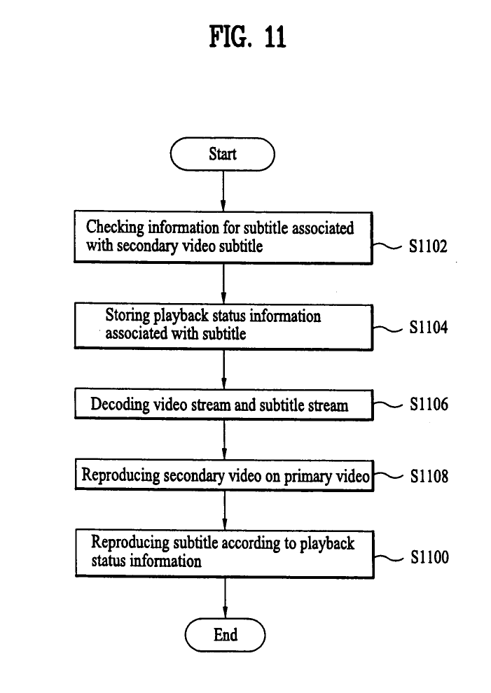

FIG. 11 is a flowchart of a method of reproducing data according to an embodiment of the present invention.

Referring to FIG. 11, an optical record player 10 according to the present invention reads and checks information associated with secondary video streams and subtitle streams included in data recorded in a recording medium (S1102). In this case, the data includes a primary video stream, at least one secondary video stream, a primary video associated subtitle stream, a secondary video associated subtitle stream and reproduction management data for managing reproduction of these streams.

For instance, in case of a recording medium input or power-on, the optical record player 10 reads a STN-table within the recording medium and then checks information associated with the secondary video stream. In this case, the information associated with the secondary video stream includes a number of secondary video stream entries, a secondary video stream entry id and the like.

As another example, from the STN-table the player 10 checks information for subtitle streams associated with the primary and secondary video streams. In this case, the subtitle includes a graphic or text subtitle associated with the secondary video. The information associated with the subtitle stream includes (number of PG textST stream entries+number of PiP PG textST stream entries), PG textST stream entry id and the like. In addition, the optical record player 10 checks a value of the “disp_s_flag” indicating whether or display of subtitle3s is enabled. And the optical record player 10 may check the secondary subtitle streams allowed according to the “combo_info_Secondary_video_PiP_PG_textST” or not.

Subsequently, the optical record player 10 stores the playback status information associated with the secondary video stream in a memory unit (S1004). The playback status information includes a secondary video stream number, information for a secondary video playback size, enablement of a secondary video screen display and the like. The secondary video stream number can indicate one of the secondary video stream entries of the STN table included in a playlist and corresponds to the secondary video stream entry identifier. The memory unit may include one or more of the player status registers (PSRs) included in the optical record player 10.

For instance, the optical record player 10 selects a secondary video stream having a lowest number from among secondary video stream numbers corresponding to the secondary video stream entry identifiers read in the step S1104 and then stores the corresponding secondary video stream number in the PSR14. Alternatively, the secondary video stream number may be selected by user input.

Also in step S1104 the optical record player 10 stores playback status information for the subtitle streams in the memory unit. This playback status information includes PG TextST stream number, PiP PG TextST stream number associated with the secondary video, whether or not subtitles are to be display, which of the PG TextST stream or PiP TextSt stream is to be displayed and the like. The subtitle stream number can indicate one of the subtitle stream entries of the STN table included in a playlist and correspond to the graphic or text subtitle stream entry identifier. Herein the graphic or text subtitle stream entry identifier is one of the identifiers allowed in the combo_info_Secondary_video_PiP_PG_textST”. The memory unit may include one of the player status registers (PSRs) included in the optical record player.

For instance, the optical record player 10 stores the secondary video stream associated graphic or text subtitle stream corresponding to the lowest graphic or text subtitle stream entry identifier read out in the step S1102 among the graphic or text subtitle stream numbers in a PSR2. Alternatively, this and other status information may be selected by user input.

Subsequently, the optical record player 10 reproduces (including decodes) the video and subtitle streams indicated in the PSRs (S1106). For example, the optical record player 10 selects and reproduces the corresponding secondary video associated graphic or text subtitle stream based on the playback status information associated with the secondary video associated graphic or text subtitle stream stored in the memory unit.

Then the optical record player 10 plays the secondary video on the primary video according to the reproduction management data (S1108). For instance, the secondary video is played back according to a playback position and size of the secondary video according to metadata that manages a playback of the secondary video included in the reproduction management data.

The graphic or text subtitle stream associated with a secondary video is output via the PG plane 650 (and/or PG plan 660) in step S1110. In this case, the selected graphic or text subtitle stream associated with secondary video should be a stream reproducible in the player.

In case that there exists a secondary video stream previously designated by a user operation (UO), playback system or application programming interface (hereinafter abbreviated API) or the like, a number of the corresponding secondary video stream shall be recorded in the memory unit (e.g., PSR 14). And, a priority of a playback sequence can be designated according to a type of a secondary video stream as well. Similarly, if there exists a subtitle stream previously designated by a user operation (UO), playback system or application programming interface (hereinafter abbreviated API) or the like, a number of the corresponding subtitle stream shall be recorded in the memory unit (e.g., PSR 2).

Furthermore, where multiple secondary video streams are available or multiple subtitles for primary or secondary video are available, it will be understood that selection may be made by a user operation (UO), playback system or application programming interface (hereinafter abbreviated API) or the like—including commands reproduced from the recording medium.

Accordingly, the present invention provides the advantage that a secondary video can be played together with a primary video and a graphic or text associated with each of the videos can be provided. Also, a content provider may provide various content and graphics or texts associated with the content. Hence, a user can simultaneously view the various content and visually obtain information associated with the content.

It will be apparent to those skilled in the art that various modifications and variations can be made in the present invention without departing from the spirit or scope of the inventions. Thus, it is intended that the present invention covers the modifications and variations of this invention.

What is claimed is:

1. A method of managing reproduction of at least one picture-in-picture presentation path, comprising:
reproducing a management table from a recording medium, the management table including combination information, the combination information indicating secondary subtitles that are combinable with at least one secondary video stream, the secondary video stream representing the picture-in-picture presentation path with respect to a primary presentation path represented by a primary video stream; and
selectively reproducing one of the secondary subtitles based on the combination information.

2. The method of claim 1, further comprising:
storing management information in a memory based on the combination information; and wherein
the selectively reproducing step selectively reproduces one of the secondary subtitles based on the management information.

3. The method of claim 2, wherein
the management information includes a secondary subtitle number identifying one of the secondary subtitles combinable with the secondary video stream; and
the selectively reproducing step selectively reproduces the secondary subtitle identified by the secondary subtitle number.

4. The method of claim 3, wherein
the combination information indicates a number of secondary subtitles combinable with the secondary video stream, and provides a secondary subtitle identifier for each of the number of secondary subtitles; and
the secondary subtitle number corresponds to one of the secondary subtitle identifiers.

5. The method of claim 4, wherein the secondary subtitle number equals one plus a value of one of the secondary subtitle identifiers.

6. The method of claim 1, wherein
the combination information indicates a number of secondary subtitles combinable with the secondary video stream, and provides a secondary subtitle identifier for each of the number of secondary subtitles; and
the secondary subtitle number corresponds to one of the secondary subtitle identifiers.

7. The method of claim 1, wherein the management table indicates a number of secondary video streams, and provides combination information for each of the number of secondary video streams.

8. A reproduction apparatus, comprising:
a memory unit; and
a controller configured to control reading of a management table from a recording medium, the management table including combination information, the combination information indicating secondary subtitles that are combinable with at least one secondary video stream, the secondary video stream representing the picture-in-picture presentation path with respect to a primary presentation path represented by a primary video stream; and
the controller configured to store management information in the memory based on the combination information; and
the controller configured to selectively reproduce one of the secondary subtitles based on the management information.

9. The apparatus of claim 8, wherein
the management information includes a secondary subtitle number identifying one of the secondary subtitles combinable with the secondary video stream; and
the controller is configured to selectively reproduces the secondary subtitle identified by the secondary subtitle number.

10. The apparatus of claim 9, wherein
the combination information indicates a number of secondary subtitles combinable with the secondary video stream, and provides a secondary subtitle identifier for each of the number of secondary subtitles; and
the secondary subtitle number corresponds to one of the secondary subtitle identifiers.

11. The apparatus of claim 10, wherein the secondary subtitle number equals one plus a value of one of the secondary subtitle identifiers.

12. The apparatus of claim 8, wherein
the combination information indicates a number of secondary subtitles combinable with the secondary video stream, and provides a secondary subtitle identifier for each of the number of secondary subtitles; and
the secondary subtitle number corresponds to one of the secondary subtitle identifiers.

13. The apparatus of claim 8, wherein the management table indicates a number of secondary video streams, and provides combination information for each of the number of secondary video streams.

14. A recording medium having a data structure for managing reproduction of at least one picture-in-picture presentation path, comprising:
a data area storing a primary video stream, the primary video stream representing a primary presentation path; and
a management area storing management information for managing reproduction of a picture-in-picture presentation path with respect to the primary presentation path, the picture-in-picture presentation path represented by a secondary video stream, the management information including combination information, the combination information indicating subtitles permitted to be displayed in combination with the secondary video stream.

15. The recording medium of claim 14, wherein the combination information indicates a number of subtitles combinable with the secondary video stream, and provides a secondary subtitle identifier for each of the number of subtitles.

16. The apparatus of claim 14, wherein the management information indicates a number of secondary video streams, and provides combination information for each of the number of secondary video streams.

17. An apparatus for recording a data structure for managing reproduction of at least one picture-in-picture presentation path, comprising:
a driver configured to drive a recording element for recording data on a recording medium; and
a controller configured to control the driver to store management information for managing reproduction of a picture-in-picture presentation path with respect to a primary presentation path, the primary presentation path represented by a primary video stream, and the picture-in-picture presentation path represented by a secondary video stream, the management information including combination information, the combination information indicating subtitles permitted to be displayed in combination with the secondary video stream.

18. The apparatus of claim 17, wherein the combination information indicates a number of subtitles combinable with the secondary video stream, and provides a secondary subtitle identifier for each of the number of subtitles.

19. A method of recording a data structure for managing reproduction of at least one picture-in-picture presentation path, comprising:
storing management information for managing reproduction of a picture-in-picture presentation path with respect to a primary presentation path, the primary presentation path represented by a primary video stream, and the picture-in-picture presentation path represented by a secondary video stream, the management information including combination information, the combination information indicating subtitles permitted to be displayed in combination with the secondary video stream.

20. The method of claim 19, wherein the combination information indicates a number of subtitles combinable with the secondary video stream, and provides a secondary subtitle identifier for each of the number of subtitles.
